(19) United States
(12) Patent Application Publication
(10) Pub. No.: US 2013/0039196 A1
(43) Pub. Date: Feb. 14, 2013

(54) OPERATION AND MAINTENANCE OF A TELECOMMUNICATIONS NETWORK

(71) Applicants: Gyula Bodog, Budapest (HU); Joerg Schmidt, Chandler, AZ (US); Clemens Suerbaum, Munich (DE)

(72) Inventors: Gyula Bodog, Budapest (HU); Joerg Schmidt, Chandler, AZ (US); Clemens Suerbaum, Munich (DE)

(73) Assignee: NOKIA SIEMENS NETWORKS OY, Espoo (FI)

(21) Appl. No.: 13/520,630

(22) PCT Filed: Jan. 12, 2010
(86) PCT No.: PCT/EP2010/050306

§ 371 Date: Nov. 2, 2012

(51) Int. Cl. H04L 12/26; H04L 12/24

(52) U.S. Cl. 370/252

(57) ABSTRACT

A management system for managing the operation of network elements in a mobile communications system, the management system comprising: a manager agent entity being capable of sending a request for the network element to measure a parameter indicated by a target to obtain a plurality of measured parameters and being capable of sending an achievement indication element related to the target; and an agent entity being capable of receiving the achievement indication element and being capable of determining a target achievement indication in respect of at least one measured parameter, the target achievement indication having been determined as a result of monitoring the correspondence between the target and the at least one measured parameter.

This invention relates to operation and maintenance of a telecommunications network. It is particularly, but not exclusively, related to optimising performance in communications systems based on self-organising networks.

As traffic patterns change away from voice towards data, bandwidth and quality of service (QoS) requirements can fluctuate wildly, and traffic load is less predictable. Handling peaks requires a network that is able to allocate bandwidth equitably to users, optimise load distribution among cells, and ensure robust mobility and handovers. Therefore, there is a need for communications systems which are able to react flexibly to traffic load which can vary considerably.

The term self-organising network (SON) is generally taken to mean a communications network in which the tasks of configuring, operating, and optimising are largely automated and so self-configuration, self-optimisation, and self-healing are possible. These tasks are carried out by dedicated SON algorithms. As a result, SON-type networks aim to reduce operational expenses while enabling a reliable user experience even under adverse conditions such as congested traffic.

Self-configuration comprises all tasks necessary to automate the deployment and commissioning of networks and the configuration of parameters. Network elements operate autonomously, running setup routines, authenticating and connecting to an Operational Support Systems (OSS), as well as linking up and swapping parameters with neighbouring network elements.

Self-optimisation serves to improve or recoup network quality by tuning network parameters on the fly. Key tasks involve brokering handovers and balancing loads among neighbouring cells. Load balancing loads—also called capacity based optimisation—between cells is applied during traffic congestion to distribute bandwidth equitably among users and minimise overloads that may deprive each user of bandwidth. This can be done in real-time.

Self-healing encompasses a set of key functions designed to cope with major service outages, including detection, root cause analysis, and outage mitigation mechanisms. Auto-restart and other automatic alarm features afford a network operator even more quick-response options.

As a result, SON algorithms can be applied to a number of different use cases such as handover optimisation, balancing optimisation, and interference optimisation and a SON-type network can improve the user experience by optimising the network more rapidly and mitigating outages as they occur. These are important capabilities because time-to-operation and time-to-repair are critical factors for every network operator.

SON algorithms are used to optimise network elements based on objectives and targets defined by the network operator. A particular network element may have a targeted success rate of carrying out an identified operation, for example a 95% handover success rate, based on a relevant key performance indicator (KPI). If a network management functionality which controls the network element determines that the network element operates such that it performs the identified operation at a success rate lower than the target, then it may instruct that a SON algorithm be used to carry out appropriate remedial action, for example re-configuration.

In a mobile communication system, such as a cellular system, radio access network (RAN) network elements account for a large share of the installation, deployment, and maintenance costs. Accordingly, SON-type functionality is currently focussed on the RAN in general and on base stations (BTS) in particular.

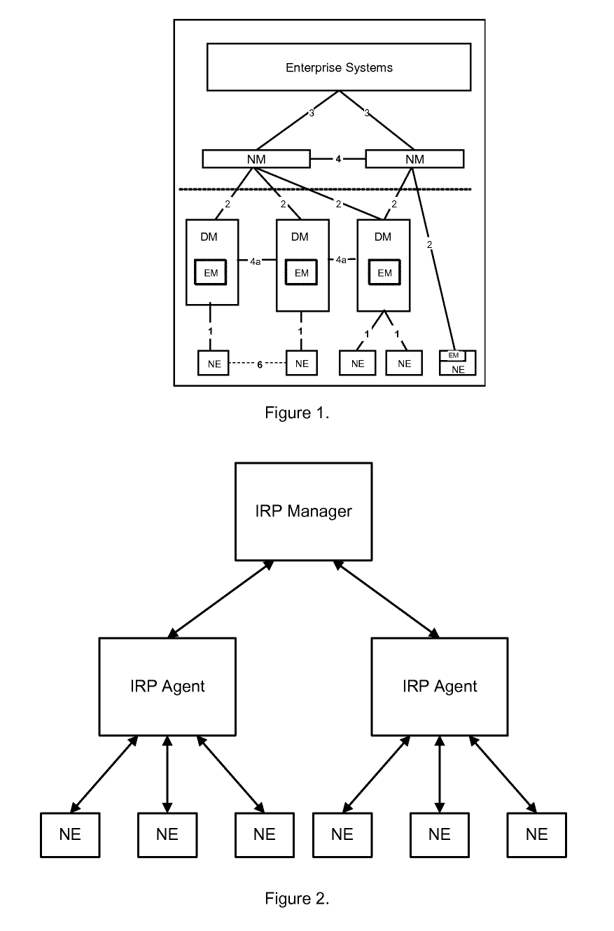

Networks often have a number of network capabilities which are not directly related to setting up and managing calls which are managed by a management architecture of a network. FIG. 1 shows a 3GPP management architecture in which the main functional blocks involved in the management of a network are presented. The architecture applies both to third generation (3G) and long term evolution (LTE) systems. The architecture is arranged in a hierarchy having at a lowest layer discrete telecommunications entities referred to as network elements (NEs) which can be managed over a specific interface. In a 3G system, the NE may be an RNC. In an LTE system, the NE may be an enhanced node B (eNodeB or eNB). Above the NE layer are element managers (EMs) which provide a package of end-user functions for the management of a set of closely related types of NEs. An EM can either be a functionality contained within a Domain Manager (DM) which provides element management functions and domain management functions for a sub-network or can be configured as part of an NE. The DMs (or EMs) are managed by Network Managers (NMs) which provide a package of end-user functions with the responsibility for the management of a network, mainly as supported by EMs but also possibly involving direct access to the NEs. The NM layer communicates with the DM/EM layer over an interface referred to as a type 2 interface or ltf N. The combination of the EM layer and the NM layer is often referred to as the management system of the network. Finally, the NM layer communicates with Enterprise Systems which are information systems used by a network operator which are not directly related to telecommunications aspects and include functionalities such as call centres, fraud detection and prevention systems, and invoicing systems.

The ltf-N connects the network management system to EMs (located in either a DM or in an NE). This connection is made by means of Integration Reference Points (IRPs). An IRP describes the information flow and associated objects or information elements which are used to carry out functions such as network configuration. An NM is able to monitor a 3G network including managing EMs over the ltf-N. This typically involves an IRP Manager in the NM layer communicating with an IRP Agent in an EM in the EM layer.

Information relating to objectives and targets is provided by an IRP Manager to an IRP Agent as a relevant attribute/parameter in SON control information. The SON control information is typically provided so that an IRP Manager can instruct an IRP Agent to monitor a network element, and in particular a KPI provided by the network element, and to compare the KPI with a corresponding target provided by the IRP Manager. Once objectives and targets have been defined, an IRP referred to as a Performance Management IRP (PM IRP) can be used to supervise results. The PM IRP defines measurements which can be used to monitor the results of SON actions. If a measured KPI fails to meet a target, the IRP Manager can then decide, if relevant criteria are met, to take appropriate action, for example it might trigger the application of an associated SON algorithm to re-configure a network element.

A SON-type network can be configured in which information controlling SON functionality is transported via the ltf-N by using an interface IRP where the controlling information is part of an operation request sent from an IRP Manager to an IRP Agent. Alternatively a SON-type network can be configured in which configuration management employs a network resource model (NRM). In this approach, the model uses objects to represent the actual managed telecommunication network resources, for example specific network elements. An NRM describes managed object classes, their associations, attributes, and operations. A Managed Object (MO) is a software object that encapsulates management characteristics and behaviour of a particular network resource. The managed object is an “instance” of a “managed object class” defined in an NRM. A managed object class has attributes that provide information used to characterise the objects that belong to the class. In addition, a managed object class can have operations that represent the behaviour relevant for that class. An instance of a managed object class is sometimes called a “managed element”.

According to a first aspect of the invention there is provided a method of managing the operation of a network element in a communications system, the method comprising:
sending a request for the network element to measure a parameter indicated by a target to obtain a plurality of measured parameters;
sending an achievement indication element related to the target; and
receiving a target achievement indication in respect of the at least one measured parameter, the target achievement indication having been determined as a result of monitoring the correspondence between the target and at least one of the measured parameters.

According to a second aspect of the invention there is provided a method of managing the operation of a network element in a communications system, the method comprising:
receiving a request for the network element to measure a parameter indicated by a target to obtain a plurality of measured parameters;
receiving an achievement indication element related to the target; monitoring the correspondence between the target and at least one of the measured parameters;
determining a target achievement indication in respect of the at least one measured parameter; and
reporting the target achievement indication.

Preferably, measured parameters relate to the same target and are sequential measurements.

Preferably, the target, the achievement indication element, and the target achievement indication, are sent in messages exchanged between entities in a network.

Preferably, the target and the achievement indication element are sent in same message. The target and the achievement indication element may be sent in different messages.

Preferably, the target is sent by a manager function to an agent function. The achievement indication element may also be so sent. The target achievement indication may be sent by an agent function to a manager function.

The target, the achievement indication element, and the target achievement indication may be conveyed between entities in a management layer superimposed on network elements in a network in order to control them.

Preferably, the target relates to a parameter concerned with the operation of the network element. In one embodiment it relates to a handover operation handled, at least in part, by the network element.

The target may be used by a management system to determine if the network element needs to be optimised. This may be carrying out appropriate remedial action, for example re-configuration of the network element. This may involve using a SON algorithm.

The manager function may exercise control over a number of agent functions, and ultimately network elements, under the control of those agent functions. The manager function may send control information to the agent functions over an ltf-N interface which then use it to monitor and/or control the configuration and/or operation of the network elements. The control information provided can include target information as an attribute or parameter. It can also include the achievement indication element.

Preferably, the correspondence between the target and a set of measured parameters is checked.

The method may relate to managing the configuration of a plurality of network elements. Preferably, the method relates to managing the operation of a plurality of network elements. The method may relate to monitoring one or more network elements. It may relate to controlling the operation of one or more network elements.

The target achievement indication may be an indication of whether a target has been achieved. It may be an indication of the tendency of a measured parameter with respect to the target, for example whether it is approaching the target, moving away from the target, or doing neither. There may be two such indications. A request may be sent indicating both indications and a response may provide both indications.

In one embodiment of the invention, the target may be sent in a message without the achievement indication element. Alternatively, a message may be sent including both the target and the achievement indication element. A response may be sent back including a target achievement indication in respect of status and a target achievement indication in respect of tendency.

Preferably, the method relates to Operation, Administration, and Maintenance (OAM) of a network. It may relate to optimising performance in communications systems based on self-organising networks. It may relate to a cellular network.

The network element may be a base station, for example a base transceiver station. It may be an eNodeB.

Preferably, information related to the management of a network element is transported by using a network resource model. The target achievement indication may be an attribute in a suitable object class, for example Control Information, defined as an object class representing the information used to control network management functions. The attribute may contain the target and information about one or more target achievement indications.

An agent function may instruct the network element to provide it periodically with measurements of the parameter indicated by the target. Therefore, as time passes, the agent function may receive a series of measurements of the parameter from the network element. The agent function may compare the measured parameters with the target.

The agent function may use an achieved performance parameter to generate a status indication. It may use a plurality of achieved performance parameters to generate a tendency indication. It may send a report comprising the achieved performance parameter, the status indication, and the tendency indication to a management system.

The management system may store a plurality of reports related to a network element in a report database. This may be accessible by using a user interface which enables users to interrogate reports relating to individual network elements. It may be able to present one report or a series of reports including the information achieved performance parameter, status indication, and tendency indication.

The user interface may present two layers of information, the information itself in terms of values or particular words or terms and another layer of information applied to values or particular words or terms in the form of colour coding. The value of a status indicator alone may determine its colour coding. The value of a tendency indicator may in some instances determine its colour coding alone and in other instances determine its colour coding in combination with the value of a status indicator.

According to a third aspect of the invention there is provided a management system for managing the operation of a network element in a communications system, the management system comprising:
a manager agent entity being capable of sending a request for the network element to measure a parameter indicated by a target to obtain a plurality of measured parameters and being capable of sending an achievement indication element related to the target; and
an agent entity being capable of receiving the achievement indication element and being capable of determining a target achievement indication in respect of at least one measured parameter, the target achievement indication having been determined as a result of monitoring the correspondence between the target and the at least one measured parameter.

According to a fourth aspect of the invention there is provided a computer program product comprising software code that when executed on a computing system performs a method of managing the operation of a network element in a communications system, the method comprising steps according to the first or second aspects of the invention.

Preferably, the computer program product has executable code portions which are capable of carrying out the steps of the method.

Preferably, the computer program product is stored on a computer-readable medium.

An embodiment of the invention will now be described, by way of example only, with reference to the accompanying drawings in which:

FIG. 1 shows a management architecture;

FIG. 2 shows another representation of a management architecture.

FIG. 1 has been described in the foregoing.

FIG. 2 shows another representation of a management architecture. In this case, it is presented to show more clearly the part played by an IRP Agent and an IRP

Manager. The management architecture comprises an IRP Manager which controls a number of IRP Agents which themselves monitor and control a number of network elements (NEs). The network elements may be BTSs and/or eNBs.

As has already been described in the foregoing, an IRP Manager exercises control over the IRP Agents, and ultimately the NEs, by sending SON control information to IRP Agents over an ltf-N interface which then use the SON control information to monitor and/or control the configuration and/or operation of NEs. The information provided can include target information as an attribute or parameter as is discussed in the foregoing. The target information is typically a parameter relating to the operation of part of the network such as a network element. It is used by comparing it to a measured parameter such as a KPI.

According to the invention, it is proposed to include with the target attribute/parameter of the SON control information additional attributes/parameters related to “status” and to “tendency”. The term “status” relates to whether or not the target has been met and the term “tendency” relates to whether the measured parameter is tending towards the target. In the following, the “status” and the “tendency” attributes/parameters are referred to by their specific names targetAchievementStatus and targetAchievementTendency. The target attribute/parameter can be included in the SON control information by defining a list type attribute which contains in the list the target (and any associated objective information) of the SON function and the additional “status” and to “tendency” attributes/parameters.

Currently it has not yet been decided how information controlling SON functionality is to be transported via the ltf-N. As referred to in the foregoing, it may be transported by specially configured interface IRPs be provided where the controlling information is part of an operation request sent from an IRP Manager to an IRP Agent. Alternatively, it may be transported by using a network resource model (NRM) where the information controlling SON functionality is modelled as object classes, with the creation of those and their attribute values being managed by the IRP Manager.

Referring now back to the invention, the first of the alternatives will now be discussed. The additional parameters targetAchievementStatus and targetAchievementTendency are included in a suitable operation. There may be a single operation which is able to convey the target information of several use cases or there may be a respective operation for respective ones of the use cases. The parameters have the following information attribute definitions and legal values:

| Attribute Name | Definition | Legal Values |
|---|---|---|
| targetAchievementStatus | This parameter | TargetAchieved, |
| | shows whether the | TargetNotAchieved |
| | related target is met. | |
| targetAchievementTendency | This parameter | Improving, stable, |
| | shows if | deteriorating, |
| | achievement of the | unknown |
| | related target has | |
| | become better or | |
| | worse or stayed the | |
| | same compared to a | |
| | previous evaluation | |
| | period. | |

The operation ReadSONinformation allows the IRP Manager to interact with the IRP Agent and be provided with information about SON activities. This may be information relevant to all use cases although it is preferred that it will be done use case by use case, for example a handover operation ReadSONinformation will cause the IRP Agent to provide to the IRP Manager SON-related information about handover management.

Accordingly, in relation to the invention, once the IRP Manager has provided relevant input parameters to the operation ReadSONinformation, the IRP Agent will provide the following output parameters:

| | | Information | |
|---|---|---|---|
| Parameter Name | Qualifier | type | Comment |
| OperationId | Mandatory | INTEGER | |
| . . . | | | |
| [SONuseCaseName]- | Mandatory | List | each list entry |
| TargetInformation | | | contains: |
| | | | target |
| | | | targetAchievement- |
| | | | Status |
| | | | targetAchievement- |
| | | | Tendency |
| . . . | | | |

However, although it is assumed that the IRP Manager will request SON information from the IRP Agent, in one embodiment of the invention, the trigger for providing the information comes from within the IRP Agent itself, for example as a result of periodic reporting. In this case the parameters provided by the IRP Agent are actually input parameters applied to an operation.

It should be noted that the operation described in the foregoing and its definition is just an example for the purposes of illustration. Although the specific parameters targetAchievementStatus and targetAchievementTendency are referred to, any parameter useable to obtain the same result can be used. The parameters can also be present in several operations, for example being defined for a number of different SON use cases.

The second of the alternatives will now be discussed. The parameters targetAchievementStatus and targetAchievementTendency are new attributes in a suitable object class, for example SONControlInformation which is defined as an object class representing the information used to control SON functions, that is instances of SON management. Such an object will contain a number of different attributes such as Id and also contains the following information attribute:

| | | | Write |
|---|---|---|---|
| | Support | Read | Quali- |
| Attribute name | Qualifier | Qualifier | fier |
| Id | Mandatory | Mandatory | — |
| . . . | | | — |
| [SONuseCaseName]TargetInformation | Mandatory | Mandatory | — |
| . . . | | | |

Other attributes are not shown for the purposes of clarity.

The new attributes have the following definition and legal values:

| Attribute Name | Definition | Legal Values |
|---|---|---|
| [SONuseCaseName]- | This defines information about the target of a | LIST, each list entry contains: |
| TargetInformation | SON [use case name] functionality. It comprises: | target |
| | The target itself; | targetAchievementStatus, |
| | Information about the status of target | values: TargetAchieved, |
| | achievement, i.e. whether the target is met; | TargetNotAchieved |
| | Information about the tendency of the target | targetAchievementTendency, |
| | achievement, i.e. if the achievement of the | values: Improving, stable, |
| | related target has become better or worse or | deteriorating, unknown |
| | stayed the same compared to a previous | |
| | evaluation period. | |

Although the specific attributes targetAchievementStatus and targetAchievementTendency are referred to, any attribute useable to obtain the same result can be used. The attributes may both be included in a general object class for SON functionality control for all SON use cases. In the implementation described in the foregoing, such a generic variant of an object class, SONControlInformation, is described, being an object class. This may have potentially several different [SONuseCaseName]TargetInformation attributes relating to the control of different SON functionalities, that is different use cases. In respect of each use case there may be the attributes targetAchievementStatus and targetAchievementTendency, along with other necessary attributes.

Alternatively, the attributes may both be included in separate object classes of this kind for each SON use case for controlling different SON functionalities. In this embodiment there are several SON[SONuseCaseName]ControlInformation information object classes with respective classes each having their own targetAchievementStatus and targetAchievementTendency attributes which are sent and received in appropriate messaging.

It should be noted that for each SON use case target, there can be several targets per use case relating to different aspects of controlling a specific SON functionality. Therefore, the associated messaging to control a specific SON functionality may have several targets and for each target there may be a respective targetAchievementStatus and targetAchievementTendency pair.

The invention provides a protocol neutral information service to be used in SON management. In order to implement this into the form of suitable messages, relevant specific protocols/languages such as CORBA or SOAP may be used.

The use of the parameters/attributes will now be described. In this case an IRP Manager sends SON control information to an IRP Agent over the ltf-N interface for the purpose of controlling operation of a network element under the control of the IRP agent. The SON control information contains target information identifying a particular parameter which is to be measured in order to determine the achieved performance of the network element and a level the achieved performance must reach in order for the network element to be considered to be working at a desired level of effectiveness, that is a target value. Accordingly, the target indicates to the IRP Agent the level of operational effectiveness that is to be maintained by the network element. In one embodiment, the network element is an eNB and the target value indicates to the IRP Agent that the eNB targeted operation is handover failure rate. In a specific example of this embodiment, the value of the target is stated as 5% which means that in order to meet the target the eNB must successfully carry out handover 95% of the time, that is to have a 5% failure rate. In addition to the target information, the SON control information also contains the parameters or attributes targetAchievementStatus and targetAchievementTendency which relate to the target and indicate to the IRP Agent that it is to generate a status indication and a tendency indication.

The IRP Agent may instruct the network element to provide it periodically with measurements of the parameter indicated by the target (the achieved performance). The network element may provide measurement data it has already obtained before receiving an instruction from the IRP Agent or may specifically carry out a measurement in response to receiving such an instruction. Therefore, as time passes, the IRP Agent receives a series of measurements of the parameter from the network element. When the IRP Agent receives a first measurement, it analyses it to determine the status is of the achieved performance and its tendency.

The IRP Agent determines the status by comparing the achieved performance with the target value to provide a status indication of “TargetAchieved” if the achieved performance is equal to or better than the target or “TargetNotAchieved” if the achieved performance is worse than the target. Therefore, in this embodiment of the invention, the target status has a binary nature.

The IRP Agent determines the tendency by comparing a current achieved performance of a particular measurement being considered with achieved performance of a previous period or time interval to provide a tendency indication of “Unknown” if there is not a previous achieved performance, “Improving” if the current achieved performance of a particular measurement is better than a previous achieved performance, “Stable” if the current achieved performance of a particular measurement is the same as a previous achieved performance (or having a sufficiently small difference between the performances), and “Deteriorating” if the current achieved performance of a particular measurement is worse than a previous achieved performance.

Therefore, the IRP Agent has the achieved performance parameter and also is able to generate the status indication and the tendency indication. It then sends a report comprising the achieved performance parameter, the status indication, and the tendency indication to the IRP Manager.

The IRP Manager stores the report in a report database or transfers it to another system for further processing. The report can be accessed from a network management centre by using a user interface enables users to interrogate reports relating to individual network elements or relating to the performance of SON functions. In one embodiment of the invention, the user interface is a graphical user interface which is able to present one report or a series of reports including the information the achieved performance parameter, the status indication, and the tendency indication. An example instance of a presentation by this graphical user interface is set out in the following report table:

| In- | | | |
|---|---|---|---|
| ter- | Achieved | | |
| val | perfor- | | |
| # | mance | targetAchievementStatus | targetAchievementTendency |
| 1 | 90% | TargetNotAchieved | Unknown |
| 2 | 94% | TargetNotAchieved | Improving |
| 3 | 96% | TargetAchieved | Improving |
| 4 | 97% | TargetAchieved | Improving |
| 5 | 97% | TargetAchieved | Stable |
| 6 | 96% | TargetAchieved | Deteriorating |
| 7 | 95% | TargetAchieved | Deteriorating |
| 8 | 94% | TargetNotAchieved | Deteriorating |
| 9 | 94% | TargetNotAchieved | Stable |
| 10 | 95% | TargetAchieved | Improving |
| . . . | | | |

Although it is not shown in this table, another layer of information is applied to each of the targetAchievementStatus parameter and the targetAchievementTendency parameter columns in the form of colour coding. In respect of the targetAchievementStatus parameter, a TargetAchieved value is presented with a green background and a TargetNotAchieved value is presented with a red background. In respect of the targetAchievementTendency parameter different coloured backgrounds are applied according to the following colour coding table:

| targetAchievement- | targetAchievement- | Colour background applied to |
|---|---|---|
| Tendency | Status | targetAchievementTendency |
| Unknown | Not relevant | white |
| Improving | Not relevant | green |
| Stable | TargetAchieved | white |
| Stable | TargetNotAchieved | yellow |
| Deteriorating | TargetAchieved | yellow |
| Deteriorating | TargetNotAchieved | red |

Applying the colour coding described above to the report table, it would be seen, for example, that for Interval #1 the targetAchievementStatus “TargetNotAchieved” would be presented in the graphical user interface with a red background and the targetAchievementTendency “Unknown” would be presented in the graphical user interface with a white background, for Interval #5 the targetAchievementStatus

“TargetAchieved” would be presented in the graphical user interface with a green background and the targetAchievementTendency “Stable” would be presented in the graphical user interface with a white background, and for Interval #9 the targetAchievementStatus “TargetNotAchieved” would be presented in the graphical user interface with a red background and the targetAchievementTendency “Stable” would be presented in the graphical user interface with a yellow background.

Therefore, it will be understood that while the value of the targetAchievementStatus alone determines its colour coding, the value of the targetAchievementTendency in some instances determines its colour coding alone and in other instances determines its colour coding in combination with the targetAchievementStatus value.

The colour coding set out in the foregoing provides an enhancement to the way in which report information can be presented to a human operator, for example working for a network operator. For example, rather than just showing the tendency of achieved performance values in individual reports, a human operator is able to readily discriminate between the targetAchievementTendency “Stable” when the targetAchievementStatus is either “TargetAchieved” or “TargetNotAchieved”, between the targetAchievementTendency “Deteriorating” when the targetAchievementStatus is either “TargetAchieved” or “TargetNotAchieved”, and to readily identify extreme conditions, for example when the targetAchievementStatus is “TargetNotAchieved” and the targetAchievementTendency is “Deteriorating”. In this way, a human operator is able to readily identify particular states and problems.

Once a user or suitably configured control system is able to review this information it can be used in a number of different ways. For example, if it is determined that SON re-configuration is not having a desired effect, that is there is not an improving tendency following re-configurations of a network element, it may be decided to disable SON reconfiguration functionality since it is not improving the operation of the network element. It may be determined that an action such as re-configuration has had a stabilising effect. In this case, this particular type of re-configuration may be applied to corresponding types of network elements elsewhere in the network.

The use of the parameters/attributes described in the foregoing, applies both to embodiments of the invention in which the SON control information (and resultant parameter/attribute values) is part of an operation request sent between an IRP Manager and an IRP Agent via an IRP interface and in which the SON control information is transported in an NRM.

The invention provides a number of advantages. A network operator is provided with a functionality which enables a review of the current status of objective/target achievement in a quick and convenient way without the need to carry out lengthy evaluation of measurement and monitoring data. Determining a correlation between a SON action and the measurements carried out in a particular network element can otherwise be cumbersome, complex and laborious. It is also possible to review the tendency of achieved performance. Therefore, the invention allows the supervision of SON functionality in a convenient way. Accordingly, this facilitates efficient management by network operators and encourages the adoption of SON mechanisms.

In a preferred implementation, the invention is implemented in 3G and LTE communications systems, being used to manage respectively BTS and eNB network elements. It may be applied in any suitable system, for example in an OAM system such as NetAct provided by Nokia Siemens Networks.

While preferred embodiments of the invention have been shown and described, it will be understood that such embodiments are described by way of example only. Numerous variations, changes and substitutions will occur to those skilled in the art without departing from the scope of the present invention. Accordingly, it is intended that the following claims cover all such variations or equivalents as fall within the spirit and the scope of the invention.

1. A method of managing the operation of a network element in a communications system, the method comprising:
sending a request for the network element to measure a parameter indicated by a target to obtain a plurality of measured parameters;
sending an achievement indication element related to the target; and
receiving a target achievement indication in respect of the at least one measured parameter, the target achievement indication having been determined as a result of monitoring the correspondence between the target and at least one of the measured parameters.

2. A method of managing the operation of a network element in a communications system, the method comprising:
receiving a request for the network element to measure a parameter indicated by a target to obtain a plurality of measured parameters;
receiving an achievement indication element related to the target;
monitoring the correspondence between the target and at least one of the measured parameters;
determining a target achievement indication in respect of the at least one measured parameter; and
reporting the target achievement indication.

3. A method according to claim 1 in which the achievement indication element, and the target achievement indication, are sent in messages exchanged between entities in a network.

4. A method according to claim 1 in which the target and the achievement indication element are sent in different messages.

5. A method according to claim 1 in which the target and the achievement indication element are sent by a manager entity to an agent entity.

6. A method according to claim 1 in which the target achievement indication is an indication of whether a target has been achieved.

7. A method according to claim 1 in which the target achievement indication is an indication of the tendency of a measured parameter with respect to the target.

8. A method according to claim 1 in which controlling information used by a manager entity to exercise control of agent entities is transported by using a network resource model where the controlling information is modelled as object classes.

9. A method according to claim 1 in which controlling information used by a manager entity to exercise control of agent entities is transported by interface IRPs as part of an operation request sent from the manager entity to the agent entity.

10. A method according to claim 1 in which reports containing the target achievement indication and the at least measured parameter are provided to a management system which is capable of graphically presenting the indication and the parameter.

11. A method according to claim 10 in which a tendency indicator is presented with a colour coding determined by the tendency indicator and a status indicator.

12. A method according to claim 1 which relates to managing the operation of a plurality of network elements.

13. A method according to claim 1 in which the method relates optimising performance in a communications system based on a self-organising network.

14. A management system for managing the operation of a network element in a communications system, the management system comprising:
a manager agent entity being capable of sending a request for the network element to measure a parameter indicated by a target to obtain a plurality of measured parameters and being capable of sending an achievement indication element related to the target; and
an agent entity being capable of receiving the achievement indication element and being capable of determining a target achievement indication in respect of at least one measured parameter, the target achievement indication having been determined as a result of monitoring the correspondence between the target and the at least one measured parameter.

15. A computer program product comprising software code that when executed on a computing system performs a method of managing the operation of a network element in a communications system, the method comprising steps according to claim 1.
